(19) United States
(12) Patent Application Publication
(10) Pub. No.: US 2025/0106604 A1
(43) Pub. Date: Mar. 27, 2025

(54) INDOOR OCCUPANCY DISTRIBUTION ANALYSIS SYSTEM AND INDOOR OCCUPANCY DISTRIBUTION ANALYSIS METHOD

(71) Applicant: LITE-ON TECHNOLOGY CORPORATION, TAIPEI CITY (TW)

(72) Inventors: Pei-Hsuan LIN, TAIPEI CITY (TW); Wei-Chuang HUANG, TAIPEI CITY (TW)

(21) Appl. No.: 18/896,235

(22) Filed: Sep. 25, 2024

Related U.S. Application Data
(60) Provisional application No. 63/585,612, filed on Sep. 27, 2023.

(30) Foreign Application Priority Data
Sep. 20, 2024 (TW) 113135772

(51) Int. Cl. H04W 4/38; H04W 4/33; H04W 64/00

(52) U.S. Cl. CPC H04W 4/38; H04W 4/33; H04W 64/003

(57) ABSTRACT

An indoor occupancy distribution analysis system is provided, which includes a base station and a network management device that communicate with each other. The base station is configured to collect performance indicators corresponding to each user equipment from the base station. The performance indicators are associated with the communication between the user equipment and the base station. The network management device is configured to receive these performance indicators, input them into a classifier, obtain the inference result output by the classifier, and derive occupancy distribution from the inference result.

### CROSS REFERENCE TO RELATED APPLICATIONS

This application claims the benefit of U.S. Provisional Application No. 63/585,612, filed on Sep. 27, 2023, the entirety of which is incorporated by reference herein. This Application claims priority of Taiwan Patent Application No. 113135772,

filed on Sep. 20, 2024, the entirety of which is incorporated by reference herein.

### BACKGROUND OF THE INVENTION

### Field of the Invention

The present invention relates to indoor occupancy distribution analysis and indoor positioning technologies, and, in particular, to an indoor occupancy distribution analysis system and an indoor occupancy distribution analysis method.

### Description of the Related Art

Indoor occupancy distribution analysis is an important application that aims to understand the distribution of people across different areas within a building. One way to implement indoor occupancy distribution analysis is through indoor positioning technology, which tracks and estimates the location of individuals inside buildings where satellite navigation systems (GPS) are almost inoperable, thereby deriving the indoor occupancy distribution.

Traditional indoor positioning technologies often rely on beacons (such as Bluetooth or ultrasound transmitters) installed within the building or tags (such as QR codes) to communicate with user equipment (UE) and thereby calculate its location. With advancements in technology, 5G-based positioning technologies are increasingly being applied to indoor positioning. 5G-based positioning can determine location through factors such as time, angle, and/or power consumption, supported by the wideband signals of New Radio (NR), and the beamforming capabilities provided by the large number of antenna elements in Multi-Input Multi-Output (MIMO) networks, thereby achieving acceptable positioning accuracy.

As described above, in implementing indoor occupancy distribution analysis, existing technologies can estimate positions using 5G-based positioning technologies. This process requires the use of the Location Management Function (LMF) within the Access and Mobility Management Function (AMF). However, in end-to-end network topologies, issues such as jitter during data packet transmission may cause delays in data reporting, resulting in decreased accuracy and response speed of indoor positioning, which in turn impacts the performance and accuracy of occupancy distribution analysis.

Accordingly, there is a need for an indoor occupancy distribution analysis system and method that can address the aforementioned issues.

### BRIEF SUMMARY OF THE INVENTION

An embodiment of the present invention provides an indoor occupancy distribution analysis system, which includes a base station and a network management device. The base station is communicable with one or more target user equipment, and is configured to collect multiple first performance indicators corresponding to each target user equipment. The first performance indicators corresponding to each target user equipment are associated with the first communication between the target user equipment and the base station. The network management device is communicable with the base station, and is configured to receive the first performance indicators corresponding to each target user equipment from the base station, input the first performance indicators corresponding to each target user equipment into a classifier to obtain the first inference result output by the classifier, and derive the first occupancy distribution from the first inference result. The first inference result indicates which of the multiple indoor areas each target user equipment is located in.

In an embodiment, the network management device is further configured to determine partitioning of the multiple indoor areas using a clustering algorithm. In a further embodiment, the clustering algorithm is k-means clustering, and the classifier is a nearest centroid classifier.

In an embodiment, during a training phase of the classifier, the base station is communicating with a reference user equipment, and is further configured to collect multiple second performance indicators associated with the second communication between the base station and the reference user equipment. The network management device is further configured to receive the second performance indicators from the base station and use the second performance indicators to train the classifier.

In an embodiment, the network management device is further configured to adjust at least one of the following based on the first occupancy distribution: the transmission power of the base station; the signal bandwidth of the base station; wind power settings of an air conditioning system; switch settings of a lighting system; and monitoring intensity settings of a security system.

In an embodiment, the indoor occupancy distribution analysis system further includes one or more camera devices that are communicable with the network management device. These camera devices are configured to capture image data associated with the multiple indoor areas. The network management device is further configured to receive the image data from the camera devices, input the image data into an image recognition model to obtain a second inference result output by the image recognition model, derive a second occupancy distribution from the second inference result, and select one of the first occupancy distribution and the second occupancy distribution by comparing the first confidence level of the classifier for the first inference result with the second confidence level of the image recognition model for the second inference result. The second inference result includes face bounding boxes.

In an embodiment, the network management device is further configured to adjust at least one of the following based on the selected one of the first occupancy distribution and the second occupancy distribution: the transmission power of the base station; the signal bandwidth of the base station; wind power settings of an air conditioning system; switch settings of a lighting system; and monitoring intensity settings of a security system.

In an embodiment, the first performance indicators include at least one of the following: a Received Signal Strength Indicator (RSSI); a Signal to Interference plus Noise Ratio (SINR); a Reference Signal Received Power (RSRP); and a Reference Signal Received Quality (RSRQ).

In an embodiment, the base station is further configured to collect the first performance indicators corresponding to each target user equipment through the performance management counter.

An embodiment of the present invention provides an indoor occupancy distribution analysis method which is carried out by a network management device. The method includes receiving multiple first performance indicators corresponding to one or more target user equipment, inputting the first performance indicators corresponding to each target user equipment into a classifier to obtain the first inference result output by the classifier, and deriving the first occupancy distribution from the first inference result. The first performance indicators corresponding to each target user equipment are associated with the first communication between the target user equipment and the base station. The first inference result indicates which of the multiple indoor areas each target user equipment is located in.

In an embodiment, the indoor occupancy distribution analysis method includes determining partitioning of multiple indoor areas using a clustering algorithm. In a further embodiment, the clustering algorithm is k-means clustering, and the classifier is a nearest centroid classifier.

In an embodiment, during a training phase of the classifier, the indoor occupancy distribution analysis method further includes receiving, from the base station, multiple second performance indicators collected by the base station associated with the second communication between the base station and a reference user equipment, and training the classifier using the second performance indicators.

In an embodiment, the indoor occupancy distribution analysis method further includes adjusting at least one of the following based on the first occupancy distribution: the transmission power of the base station; the signal bandwidth of the base station; wind power settings of an air conditioning system; switch settings of a lighting system; and monitoring intensity settings of a security system.

In an embodiment, the indoor occupancy distribution analysis method further includes receiving, from one or more camera devices, image data captured by the camera devices associated with the multiple indoor areas, inputting the image data into an image recognition model to obtain a second inference result output by the image recognition model, deriving a second occupancy distribution from the second inference result, and selecting one of the first occupancy distribution and the second occupancy distribution by comparing the first confidence level of the classifier for the first inference result with the second confidence level of the image recognition model for the second inference result.

In an embodiment, the indoor occupancy distribution analysis method further includes adjusting at least one of the following based on the selected one of the first occupancy distribution and the second occupancy distribution: the transmission power of the base station; the signal bandwidth of the base station; wind power settings of an air conditioning system; switch settings of a lighting system; and monitoring intensity settings of a security system.

The indoor occupancy distribution analysis solution provided by the embodiments of the present disclosure estimates the location of user equipment based on the features of communication data and can achieve approximately 80% accuracy with only one single base station, which is equivalent to achieving Rel-16 positioning performance using Rel-15 hardware. This not only improves the accuracy and real-time capabilities of indoor occupancy distribution analysis but also meets the requirements of various application scenarios. Furthermore, the indoor occupancy distribution analysis solution can be integrated with various applications to achieve power-saving purposes.

### BRIEF DESCRIPTION OF THE DRAWINGS

The present invention can be more fully understood by reading the subsequent detailed description and examples with references made to the accompanying drawings, wherein:

FIG. 1 is the system architecture diagram of an indoor occupancy distribution analysis system, according to an embodiment of the present disclosure;

FIG. 2 provides an example of the partitioning of indoor areas;

FIG. 3 is the flow diagram of an indoor occupancy distribution analysis method, according to an embodiment of the present disclosure;

FIG. 4 is the system architecture diagram of the indoor occupancy distribution analysis system during the training phase of the classifier, according to an embodiment of the present disclosure; and

FIG. 5 is the system architecture diagram of an indoor occupancy distribution analysis system, according to an embodiment of the present disclosure

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

It must be understood that the terms “including” and “comprising” are used in the specification to indicate the existence of specific technical features, numerical values, method steps, process operations, elements and/or components, but do not exclude additional technical features, numerical values, method steps, process operations, elements, components, or any combination of the above.

Ordinal terms used in the claims, such as “first,” “second,” “third,” etc., are only for convenience of explanation, and do not imply any precedence relation between one another.

The descriptions of the embodiments of the device or system herein are also applicable to the embodiments of the method, and vice versa.

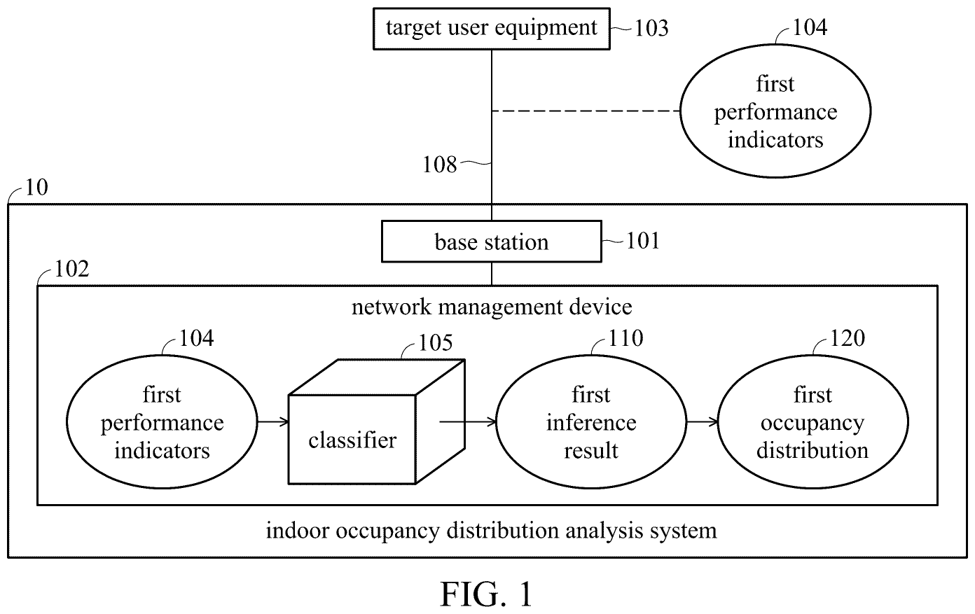

FIG. 1 is the system architecture diagram of an indoor occupancy distribution analysis system 10, according to an embodiment of the present disclosure. As shown in FIG. 1, the indoor occupancy distribution analysis system 10 includes a base station 101 and a network management device 102. The base station 101 is communicable with the network management device 102 and the target user equipment 103.

The base station 101 is a high-power, multi-channel, bidirectional wireless transmission station used to provide wireless access services to user equipment and to transmit the signal traffic generated by the communication between it and the user equipment to the core network via a backhaul network. Depending on the actual application scenarios of indoor occupancy distribution analysis, the base station 101 can be deployed in any indoor space, such as residential areas, exhibition venues, retail stores, factories, and office spaces, but the present disclosure is not limited thereto.

The network management device 102 is a computer device deployed in the core network, used to monitor, manage, and configure various devices and services within the entire mobile communication network. The network management device 102 may include a processing unit and a storage unit, although these components are not illustrated in FIG. 1. The processing unit may include one or more general-purpose or specialized processors and combinations thereof, used to execute certain steps of the indoor occupancy distribution analysis method of the present disclosure (to be detailed hereinafter). In a typical embodiment, the processing unit may include a Central Processing Unit (CPU) and a Graphics Processing Unit (GPU), where the GPU is more efficient than the CPU in handling machine learning-related tasks. Therefore, parts of the indoor occupancy distribution analysis method involving machine learning can be assigned to the GPU for execution. The storage unit may be any device containing non-volatile memory, such as Read-Only Memory (ROM), Electrically-Erasable Programmable Read-Only Memory (EEPROM), flash memory, or Non-Volatile Random Access Memory (NVRAM), including but not limited to hard disk drives (HDD), solid-state drives (SSD), or optical discs. It is used to store programs and other data required to perform the indoor occupancy distribution analysis method of the present disclosure (e.g., communication performance indicator data and machine learning models). A program is a sequence or set of instructions for execution by the network management device 102. In various embodiments, the program may be written in any one or more programming languages, such as Java, C, C #, C++, and Python, but the present disclosure is not limited thereto. Upon loading the program from the storage unit, the processing unit can execute the indoor occupancy distribution analysis method of the present disclosure (to be detailed hereinafter).

The target user equipment 103 may be a smartphone, tablet, or any other terminal mobile device capable of connecting to a mobile network. It should be noted that, although only one target user equipment 103 is illustrated in FIG. 1, in various embodiments of the present disclosure, the base station 101 may communicate with multiple target user equipment simultaneously. The holders of these target user equipment serve as the subjects of indoor occupancy distribution analysis in various embodiments of the present disclosure.

According to the embodiments of the present disclosure, the base station 101 is configured to collect multiple first performance indicators corresponding to each target user equipment, such as the first performance indicators 104 corresponding to the target user equipment 103. Specifically, the first performance indicators 104 are associated with the first communication 108 between the target user equipment 103 and the base station 101. Subsequently, the first performance indicators 104 are transmitted to the network management device 102 in the core network.

In an embodiment, the base station 101 collects the first performance indicators 104 through a performance management counter (PM counter). The performance management counter can be implemented by dedicated hardware such as an Application Specific Integrated Circuit (ASIC) or a Field Programmable Gate Array (FPGA), or by firmware or embedded software running on the control plane of the base station 101, but the present disclosure is not limited thereto.

In an embodiment, the first performance indicators 104 may include communication-related performance indicators such as Received Signal Strength Indicator (RSSI), Signal to Interference plus Noise Ratio (SINR), Reference Signal Received Power (RSRP), Reference Signal Received Quality (RSRQ), or any combination thereof, as feature representations of the first communication 108, but the present disclosure is not limited thereto.

According to the embodiments of the present disclosure, the network management device 102 receives the first performance indicators 104 from the base station 101. Subsequently, the network management device 102 inputs the first performance indicators 104 into the trained classifier 105 to obtain the first inference result 110 output by the classifier, and then derives the first occupancy distribution 120 from the first inference result 110.

The classifier 105 can be implemented using machine learning models or algorithms such as neural networks, decision trees, logistic regression, naive Bayes, random forests, or Support Vector Machines (SVM), but the present disclosure is not limited thereto.

The first inference result 110 can indicate which of the multiple indoor areas the target user equipment 103 is located in, while the first occupancy distribution 120 represents the number distribution of people across the indoor areas. In further embodiments, the first occupancy distribution 120 can be visually presented as a bar chart or heat map, but the present disclosure is not limited thereto.

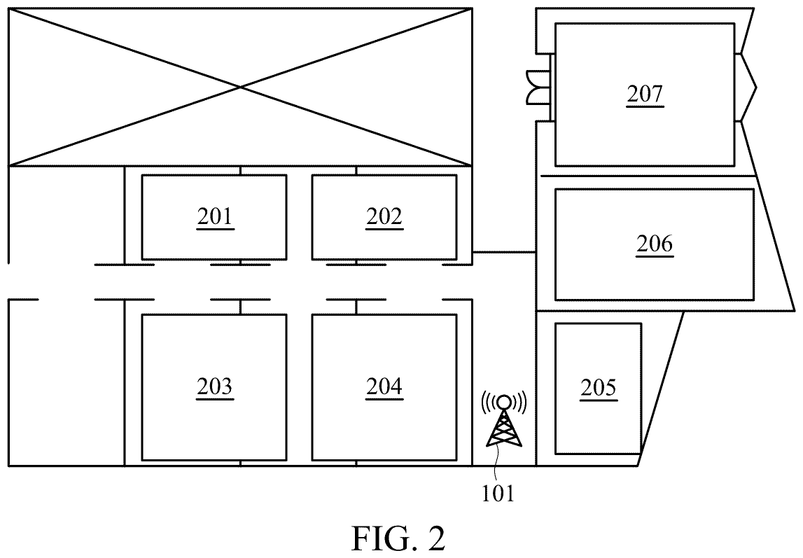

Refer to FIG. 2, which provides an example of the partitioning of indoor areas. In this example, the first inference result 110 can indicate which of the indoor areas 201-207 the target user equipment 103 and other user equipment are located in. Subsequently, the network management device 102 can derive the first occupancy distribution 120 from the first inference result 110, representing the number of people in each of the indoor areas 201-207. For example, if the first inference result 110 indicates that out of 17 target user equipment, 2 are located in indoor area 201, 10 are located in indoor area 204, and 5 are located in indoor area 207, the network management device 102 can derive that the number of people in indoor areas 201-207 are 2, 0, 0, 10, 0, 0, and 5, respectively.

In an embodiment, the partitioning of indoor areas, such as indoor areas 201-207 shown in FIG. 2, can be predetermined. For example, these indoor areas can be partitioned based on the physical structure of the building, layout design, or functional usage. However, in some embodiments, if there are no predefined partitions, the partitioning of indoor areas can be determined using a clustering algorithm.

Specifically, the clustering algorithm can automatically partition indoor areas based on a set of parameters related to the indoor space. These parameters may include, but are not limited to, distance to the base station, historical movement trajectories of people, and/or communication-related performance indicators such as RSSI, SINR, RSRP, and RSRQ. Through the clustering algorithm, data with high similarity can be grouped together, and the indoor areas can be partitioned based on the clustering results. For example, features such as RSSI, SINR, RSRP, and RSRQ can be used for clustering, grouping areas with similar features into the same indoor area, thereby generating dynamic and adaptive area partitions. Compared to predefined partitions, this automatic partitioning method can accommodate irregular building structures or complex application scenarios, enhancing the system's flexibility and adaptability.

In further embodiments, the aforementioned clustering algorithm can be k-means clustering. In k-means clustering, each cluster is represented by a mean vector of all members within the cluster. The k-means clustering process begins by randomly selecting k initial centroids based on the specified k value (i.e., the expected number of partitions). Then, data points are assigned to the nearest centroid, and the positions of the centroids and the assignments of data points are iteratively adjusted until convergence is reached, thereby completing the partitioning of indoor areas. Additionally, in this embodiment, the classifier 105 can be a nearest centroid classifier. The nearest centroid classifier determines which cluster the target data is most similar to based on the centroids, and assigns it to the corresponding cluster. Specifically, when the first performance indicators 104 corresponding to the target user equipment 103 are input into the classifier 105, the classifier 105 calculates the distance from the first performance indicators 104 to each of the k centroids obtained from the k-means clustering, and assigns the target user equipment 103 to the indoor area corresponding to the nearest centroid.

In an embodiment, the network management device 102 can adaptively adjust the operational parameters of other electronic devices based on the first occupancy distribution 120, such as the transmission power of the base station 101, the signal bandwidth of the base station 101, the wind power settings of the air conditioning system, the switch settings of the lighting system, the monitoring intensity settings of the security system, or any combination thereof, to achieve power-saving purposes. The adjustment range of these parameters can be determined using a machine learning-based regression model, a rule-based algorithm, or a lookup table with interpolation, but the present disclosure is not limited thereto.

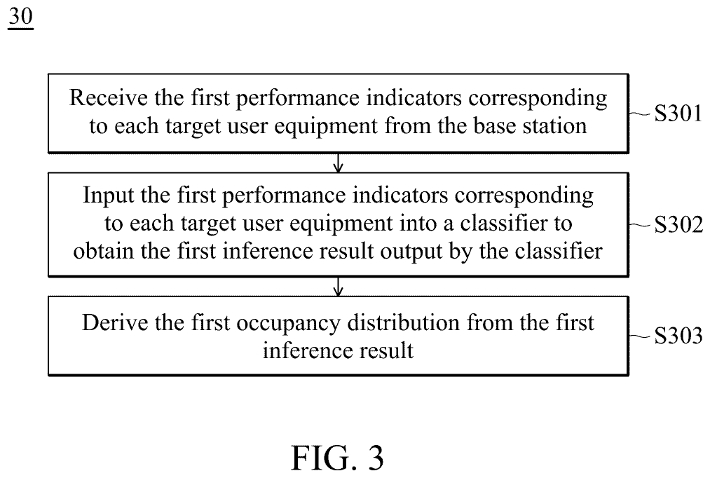

FIG. 3 is a flow diagram of an indoor occupancy distribution analysis method 30, according to an embodiment of the present disclosure. As shown in FIG. 3, the indoor occupancy distribution analysis method 30 may include steps S301-S303. These steps are implemented by the network management device 102 shown in FIG. 1. Please refer to both FIG. 3 and FIG. 1 for a clearer understanding of the embodiments of the present disclosure.

In step S301, the network management device 102 receives the first performance indicators collected by the base station 101 corresponding to each target user equipment, such as the first performance indicators 104 corresponding to the target user equipment 103. The method 300 then proceeds to step S302.

In step S302, the network management device 102 inputs the first performance indicators corresponding to each target user equipment into the classifier 105 to obtain the first inference result 110 output by the classifier 105. The method 300 then proceeds to step S303.

In step S303, the network management device 102 derives the first occupancy distribution 120 from the first inference result 110.

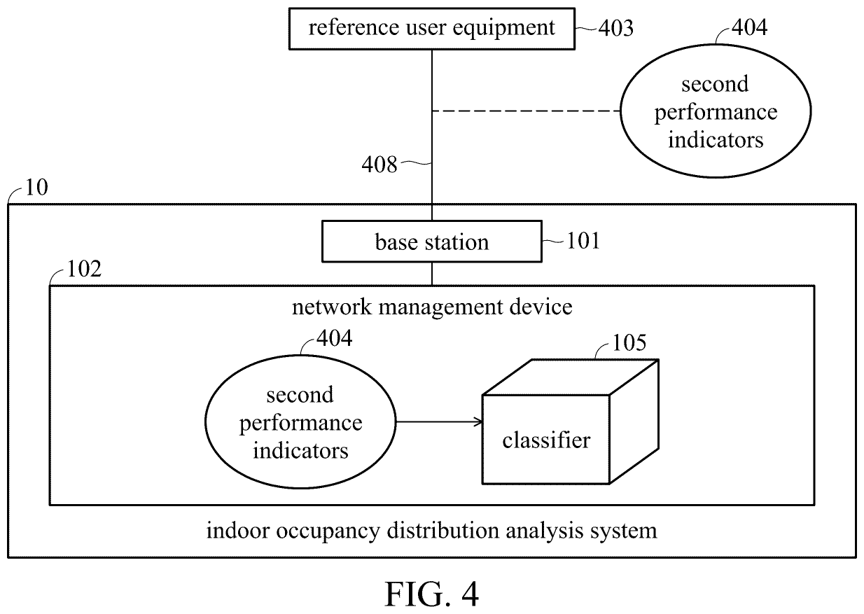

FIG. 4 is a system architecture diagram of the indoor occupancy distribution analysis system 10 during the training phase of the classifier 105 according to an embodiment of the present disclosure. As shown in FIG. 4, during the training phase of the classifier 105, the base station 101 communicates with the reference user equipment 403 and collects multiple second performance indicators 404 associated with the second communication 408 between the base station 101 and the reference user equipment 403. Subsequently, the network management device 102 receives the second performance indicators 404 from the base station 101 and uses them to train the classifier 105.

Similar to the target user equipment 103 in FIG. 1, the reference user equipment 403 can be a smartphone, tablet, or any other terminal mobile device capable of connecting to a mobile network. However, in the context shown in FIG. 4, the role of the reference user equipment 403 is to collect training data for the classifier 105, namely the second performance indicators 404.

In an embodiment, similar to the aforementioned first performance indicators 104, which may include Received Signal Strength Indicator (RSSI), Signal to Interference plus Noise Ratio (SINR), Reference Signal Received Power (RSRP), Reference Signal Received Quality (RSRQ), or any combination thereof, the second performance indicators 404 may also include these performance indicators as feature representations of the second communication 408. In a further embodiment, in addition to the second performance indicators 404, the training data for the classifier 105 may further include labels associated with the second communication 408, such as distance, predefined block ID, or base station ID, but the present disclosure is not limited thereto.

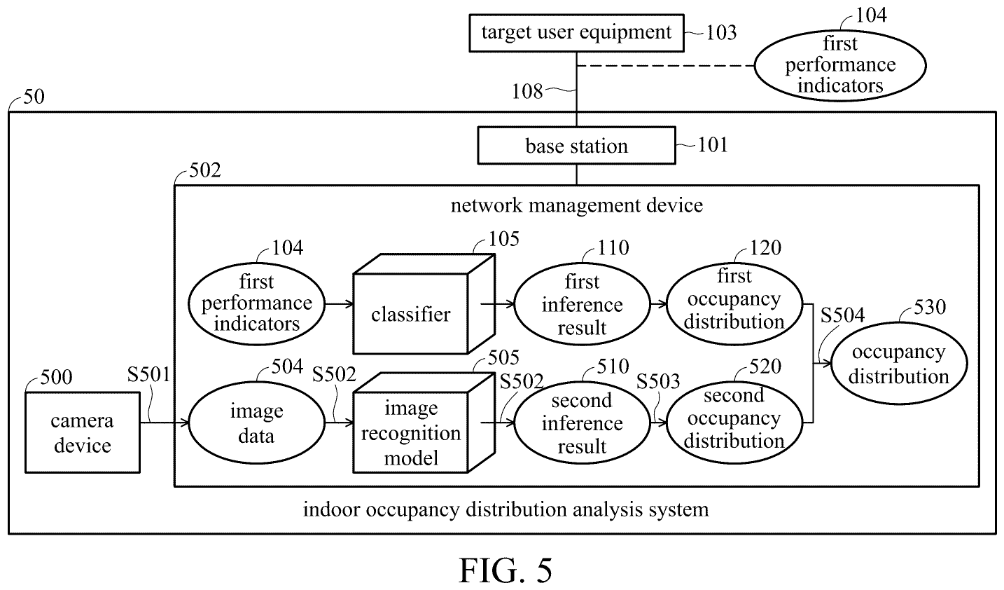

FIG. 5 is a system architecture diagram of an indoor occupancy distribution analysis system 50, according to an embodiment of the present disclosure. As shown in FIG. 5, compared to the indoor occupancy distribution analysis system 10 in FIG. 1, the indoor occupancy distribution analysis system 50 further includes a camera device 500 configured to capture image data 504 associated with multiple indoor areas and provide the image data 504 to the network management device 502. It should be noted that, although only one camera device 500 is illustrated in FIG. 5, various embodiments of the present disclosure may involve the use of multiple camera devices to capture more comprehensive image data. Additionally, compared to the network management device 102 in FIG. 1, the network management device 502 is further configured to perform steps S501-S504.

In step S501, the network management device 502 receives the image data 504 from the camera device 500 and then proceeds to step S502.

In step S502, the network management device 502 inputs the image data 504 into the image recognition model 505 to obtain the second inference result 510 output by the image recognition model 505, and then proceeds to step S503.

The image recognition model 505 can be any machine learning model used for face detection tasks, such as convolutional neural network (CNN), You Only Look Once (YOLO), or Support Vector Machine (SVM), but the present disclosure is not limited thereto. The second inference result 510 output by the image recognition model 505 includes face bounding boxes. A face bounding box is a rectangular box surrounding the detected face, used to determine the specific position and range of the face in the image. These bounding boxes contain the coordinate information of the face, indicating the position of each detected face in the image.

In step S503, the network management device 502 derives the second occupancy distribution 520 from the second inference result 510, and then proceeds to step S504. Specifically, the network management device 502 can deduce the number of people in the indoor area corresponding to the scene captured by the camera device 500 by counting the number of face bounding boxes in the second inference result 510. In other words, the presence of each face bounding box in the image corresponds to one person in a specific area, thereby determining the occupancy distribution for each area.

In step S504, the network management device 502 selects one of the first occupancy distribution 120 and the second occupancy distribution 520 as the final output occupancy distribution 530 by comparing the first confidence level of the classifier 105 for the first inference result 110 with the second confidence level of the image recognition model 505 for the second inference result 510. Specifically, a higher confidence level indicates that the model's output is more reliable and accurate. Therefore, if the second confidence level of the image recognition model 505 for the second inference result 510 is higher than the first confidence level of the classifier 105 for the first inference result 110, the second occupancy distribution 520 is selected as the final output occupancy distribution 530, and vice versa.

In an embodiment, the network management device 502 can adaptively adjust the operational parameters of other electronic devices based on the selected occupancy distribution 530, such as the transmission power of the base station 101, the signal bandwidth of the base station 101, the wind power settings of the air conditioning system, the switch settings of the lighting system, the monitoring intensity settings of the security system, or any combination thereof, to achieve power-saving purposes. The specific methods for adjusting these parameters and their application scenarios have been described above and is not reiterated here.

The indoor occupancy distribution analysis solution provided by the embodiments of the present disclosure estimates the location of user equipment based on the features of communication data and can achieve approximately 80% accuracy with only one base station, which is equivalent to achieving Rel-16 positioning performance using Rel-15 hardware. This not only improves the accuracy and real-time capabilities of indoor occupancy distribution analysis but also meets the requirements of various application scenarios. Furthermore, the indoor occupancy distribution analysis solution can be integrated with various applications to achieve power-saving purposes.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An indoor occupancy distribution analysis system, comprising:
a base station, communicable with one or more target user equipment, and configured to collect multiple first performance indicators corresponding to each target user equipment, wherein the first performance indicators corresponding to each target user equipment are associated with a first communication between that target user equipment and the base station; and
a network management device, communicable with the base station, and configured to perform the following steps:
receiving the first performance indicators corresponding to each target user equipment from the base station;
inputting the first performance indicators corresponding to each target user equipment into a classifier to obtain a first inference result output by the classifier, wherein the first inference result indicates which of the multiple indoor areas each target user equipment is located in; and
deriving a first occupancy distribution from the first inference result.

2. The indoor occupancy distribution analysis system as claimed in claim 1, wherein the network management device is further configured to determine partitioning of the multiple indoor areas using a clustering algorithm.

3. The indoor occupancy distribution analysis system as claimed in claim 2, wherein the clustering algorithm is k-means clustering, and the classifier is a nearest centroid classifier.

4. The indoor occupancy distribution analysis system as claimed in claim 1, wherein during a training phase of the classifier, the base station is communicating with a reference user equipment and is further configured to collect multiple second performance indicators associated with a second communication between the base station and the reference user equipment; and
wherein the network management device is further configured to receive the second performance indicators from the base station and use the second performance indicators to train the classifier.

5. The indoor occupancy distribution analysis system as claimed in claim 1, wherein the network management device is further configured to adjust at least one of the following based on the first occupancy distribution:
a transmission power of the base station;
a signal bandwidth of the base station;
wind power settings of an air conditioning system;
switch settings of a lighting system; and
monitoring intensity settings of a security system.

6. The indoor occupancy distribution analysis system as claimed in claim 1, further comprising:
one or more camera devices, communicable with the network management device, configured to capture image data associated with the multiple indoor areas;
wherein the network management device is further configured to perform the following steps:
receiving the image data from the camera devices;
inputting the image data into an image recognition model to obtain a second inference result output by the image recognition model, wherein the second inference result includes face bounding boxes;
deriving a second occupancy distribution from the second inference result; and
selecting one of the first occupancy distribution and the second occupancy distribution by comparing a first confidence level of the classifier for the first inference result with a second confidence level of the image recognition model for the second inference result.

7. The indoor occupancy distribution analysis system as claimed in claim 6, wherein the network management device is further configured to adjust at least one of the following based on the selected one of the first occupancy distribution and the second occupancy distribution:
a transmission power of the base station;
a signal bandwidth of the base station;
wind power settings of an air conditioning system;
switch settings of a lighting system; and
monitoring intensity settings of a security system.

8. The indoor occupancy distribution analysis system as claimed in claim 1, wherein the first performance indicators include at least one of the following:
a Received Signal Strength Indicator (RSSI);
a Signal to Interference plus Noise Ratio (SINR);
a Reference Signal Received Power (RSRP); and
a Reference Signal Received Quality (RSRQ).

9. The indoor occupancy distribution analysis system as claimed in claim 1, wherein the base station is further configured to collect the first performance indicators corresponding to each target user equipment through a performance management counter.

10. An indoor occupancy distribution analysis method, carried out by a network management device, the method comprising:
receiving, from a base station, multiple first performance indicators corresponding to one or more target user equipment, wherein the first performance indicators corresponding to each target user equipment are associated with a first communication between that target user equipment and the base station;
inputting the first performance indicators corresponding to each target user equipment into a classifier to obtain a first inference result output by the classifier, wherein the first inference result indicates which of the multiple indoor areas each target user equipment is located in; and
deriving a first occupancy distribution from the first inference result.

11. The indoor occupancy distribution analysis method as claimed in claim 10, further comprising:
determining partitioning of multiple indoor areas using a clustering algorithm.

12. The indoor occupancy distribution analysis method as claimed in claim 11, wherein the clustering algorithm is k-means clustering, and the classifier is a nearest centroid classifier.

13. The indoor occupancy distribution analysis method as claimed in claim 10, during a training phase of the classifier, further comprising:
receiving, from the base station, multiple second performance indicators associated with a second communication between the base station and a reference user equipment; and
training the classifier using the second performance indicators.

14. The indoor occupancy distribution analysis method as claimed in claim 10, further comprising:
adjusting at least one of the following based on the first occupancy distribution:
a transmission power of the base station;
a signal bandwidth of the base station;
wind power settings of an air conditioning system;
switch settings of a lighting system; and
monitoring intensity settings of a security system.

15. The indoor occupancy distribution analysis method as claimed in claim 10, further comprising:
receiving, from one or more camera devices, image data associated with the multiple indoor areas;
inputting the image data into an image recognition model to obtain a second inference result output by the image recognition model, wherein the second inference result includes face bounding boxes;
deriving a second occupancy distribution from the second inference result; and
selecting one of the first occupancy distribution and the second occupancy distribution by comparing a first confidence level of the classifier for the first inference result with a second confidence level of the image recognition model for the second inference result.

16. The indoor occupancy distribution analysis method as claimed in claim 15, further comprising:
adjusting at least one of the following based on the selected one of the first occupancy distribution and the second occupancy distribution:
a transmission power of the base station;
a signal bandwidth of the base station;
wind power settings of an air conditioning system;
switch settings of a lighting system; and
monitoring intensity settings of a security system.

17. The indoor occupancy distribution analysis method as claimed in claim 10, wherein the first performance indicators include at least one of the following:
a Received Signal Strength Indicator (RSSI);
a Signal to Interference plus Noise Ratio (SINR);
a Reference Signal Received Power (RSRP); and
a Reference Signal Received Quality (RSRQ).
